(19) United States
(12) Patent Application Publication
(10) Pub. No.: US 2026/0078663 A1
(43) Pub. Date: Mar. 19, 2026

(54) TUBULAR RUNNING OPERATIONS WITH FREQUENCY SPECTRUM ANALYSIS

(71) Applicant: WEATHERFORD TECHNOLOGY HOLDINGS, LLC, HOUSTON, TX (US)

(72) Inventors: Benjamin SACHTLEBEN, Hannover (DE); Mohammed ZAFARUDDIN, Hannover (DE); Lizabeth J. LY, Hannover (DE); Klaus KREMS, Hannover (DE); David GEISSLER, Hannover (DE)

(21) Appl. No.: 18/904,605

(22) Filed: Oct. 2, 2024

Related U.S. Application Data
(60) Provisional application No. 63/696,542, filed on Sep. 19, 2024.

(51) Int. Cl. E21B 44/00; G06F 17/14

(52) U.S. Cl. CPC E21B 44/00; G06F 17/142; G06F 17/148

(57) ABSTRACT

A method can include obtaining sensor data during a tubular running operation, converting the sensor data to frequency domain, identifying at least one frequency pattern in the sensor data, and comparing the identified at least one frequency pattern to a database of known frequency patterns. An apparatus can include at least one sensor configured to output sensor data in a tubular running operation, and a control system comprising a frequency spectrum analysis module configured to convert the sensor data to frequency domain.

### CROSS-REFERENCE TO RELATED APPLICATION

This application claims the benefit of the filing date of U.S. provisional application no. 63/696,542 filed on 19 Sep. 2024. The entire disclosure of the prior application is incorporated herein by this reference for all purposes.

### BACKGROUND

This disclosure relates generally to equipment utilized and operations performed in conjunction with a subterranean well and, in an example described below, more particularly provides for tubular running operations with frequency spectrum analysis of sensor data.

Various types of tubular components can be threaded together to form tubular strings for use in a well. Tubulars used in wells can include protective wellbore linings (such as, casing, liner, etc.), production or injection conduits (such as, production tubing, injection tubing, screens, etc.), drill pipe and drill collars, and associated components (such as tubular couplings).

Threaded connections between tubulars are made-up during tubular running operations, and the threaded connections are broken-out when a tubular string is retrieved from a well. The make-up and break-out processes should be performed quickly, efficiently and safely.

It will, therefore, be readily appreciated that improvements are continually needed in the art of evaluating threaded connection quality at a well. The present disclosure provides such improvements to the art of running tubular strings into and out of a subterranean well.

### BRIEF DESCRIPTION OF THE DRAWINGS

FIG. 1 is a representative partially cross-sectional view of an example of a well system and associated method which can embody principles of this disclosure.

FIG. 2 is a representative side view of an example tubular running operation with an apparatus for identifying defects or anomalies in the operation.

FIG. 3 is a representative schematic view of an example workflow of the apparatus.

FIG. 4 is a representative flowchart for an example of a method for use with a tubular running operation.

### DETAILED DESCRIPTION

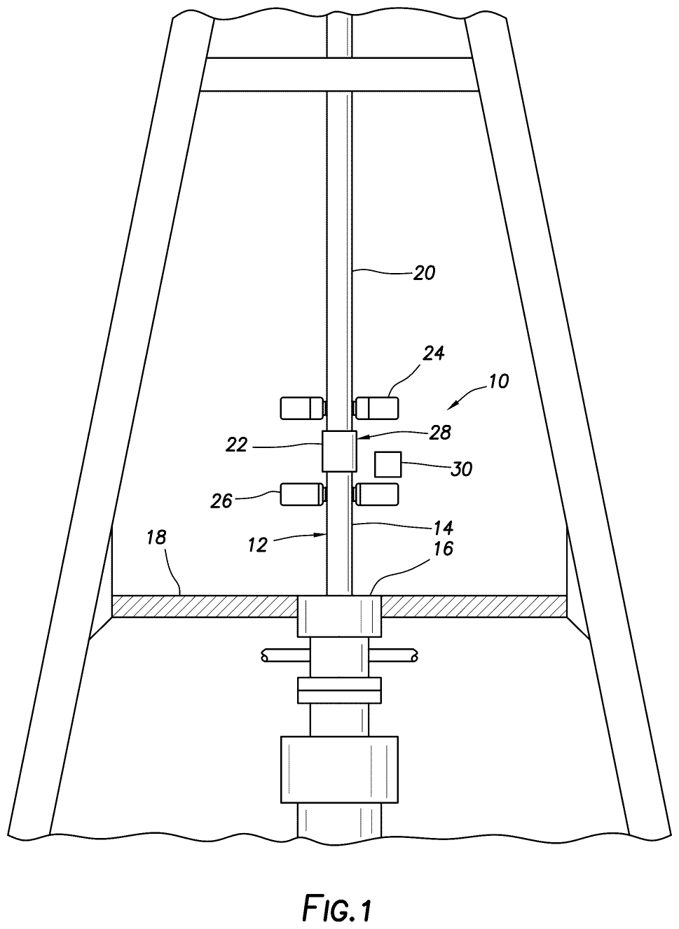

Representatively illustrated in FIG. 1 is a system 10 for use with a subterranean well, and an associated method, which can embody principles of this disclosure. However, it should be clearly understood that the well system 10 and method are merely one example of an application of the principles of this disclosure in practice, and a wide variety of other examples are possible. Therefore, the scope of this disclosure is not limited at all to the details of the well system 10 and method described herein and/or depicted in the drawings.

In the FIG. 1 example, a tubular string 12 is being assembled and deployed into a well. The tubular string 12 in this example is a production or injection tubing string, but in other examples the tubular string could be a casing, liner, drill pipe, completion, stimulation, testing or other type of tubular string. The scope of this disclosure is not limited to use of any particular type of tubular string, or to any particular tubular components connected in a tubular string.

As depicted in FIG. 1, a tubular 14 is suspended near its upper end by means of a rotary table 16, which may comprise a pipe handling spider and/or safety slips to grip the tubular 14 and support a weight of the tubular string 12. In this manner, the upper end of the tubular 14 extends upwardly through a rig floor 18 in preparation for connecting another tubular 20 to the tubular string 12.

In this example, a tubular coupling 22 is made-up to the upper end of the tubular 14 prior to the tubular 14 being connected in the tubular string 12. The coupling 22 is internally threaded in each of its opposite ends.

In conventional well operations, it is common for a threaded together tubular and coupling to be referred to as a “joint” and for threaded together joints to be referred to as a “stand” of tubing, casing, liner, pipe, etc. However, in some examples, a separate coupling may not be used; instead one end (typically an upper “box” end of a joint) is internally threaded and the other end (typically a lower “pin” end of the joint) is externally threaded, so that successive joints can be threaded directly to each other.

Thus, the scope of this disclosure can encompass the use of a separate coupling with a tubular, or the use of a tubular without a separate coupling (in which case the coupling can be considered to be integrally formed with, and a part of, the tubular). In the FIG. 1 example, the coupling 22 can also be considered to be a tubular, since it is a tubular component connected in the tubular string 12.

To make-up a threaded connection 28 between the tubular 20 and the coupling 22, a set of tongs or rotary and backup clamps 24, 26 are used. The rotary clamp 24 in the FIG. 1 example is used to grip, rotate and apply torque to the upper tubular 20 as it is threaded into the coupling 22.

The backup clamp 26 in the FIG. 1 example is used to grip and secure the lower tubular 14 against rotation, and to react the torque applied by the rotary clamp 24. The rotary clamp 24 and the backup clamp 26 may be separate devices, or they may be components of a rig apparatus known to those skilled in the art as an “iron roughneck” or a tong assembly.

In one example, the rotary clamp 24 and backup clamp 26 may be components of tubular running equipment, such as the VERO™ tong system marketed by Weatherford International, Inc. of Houston, Texas USA. In this example, the rotary clamp 24 may be a mechanism of the tong system that rotates and applies torque to the upper tubular 20, and the backup clamp 26 may be a backup mechanism of the tong system that reacts the applied torque and prevents rotation of the lower tubular 14.

Note that it is not necessary for the tubulars 14, 20 (and coupling 22, if used) to be vertical in the tubular make-up operation. The tubulars 14, 20 could instead be horizontal or otherwise oriented. Additional systems in which the principles of this disclosure may be incorporated include the CAM™, COMCAM™ and TORKWRENCH™ bucking systems marketed by Weatherford International, Inc.

In other examples, the tubular running equipment can comprise a top drive. In these examples, the top drive can be used to apply torque and rotation to the upper tubular 20. As used herein, the term “running” in contexts such as “tubular running equipment” is used to refer to deploying tubulars into a well (e.g., by connecting the tubulars together in a tubular string lowered into the well), or retrieving the tubulars from the well.

In the FIG. 1 example, after the upper tubular 20 is properly made-up to the lower tubular 14 or coupling 22, the tubular string 12 can be lowered further into the well, and the make-up operation can be repeated to connect another stand to the upper end of the tubular string. In this manner, the tubular string 12 is progressively deployed into the well by connecting successive stands to the upper end of the tubular string. In some examples, an individual tubular component may be added to the tubular string 12, instead of a stand.

In the FIG. 1 method, it is desired to be able to detect defects or anomalies when the threaded connection 28 is made-up or broken-out. In this manner, if there are no defects or anomalies identified, the tubular running operation can proceed efficiently. However, if a defect or anomaly is identified, corrective action can be taken immediately to mitigate any problem, and then the tubular running operation can resume. Preferably the evaluation of the tubular running operation is performed automatically, in real time, and without the need for personnel to be present on the rig floor 18.

An apparatus 30 is included in the FIG. 1 system 10 for evaluating the tubular running operation (such as, during make-up or break-out of threaded connections 28). As described more fully below, the apparatus 30 can include a variety of different sensors to obtain measurements used by a control system to identify any defects or anomalies in the tubular running operation.

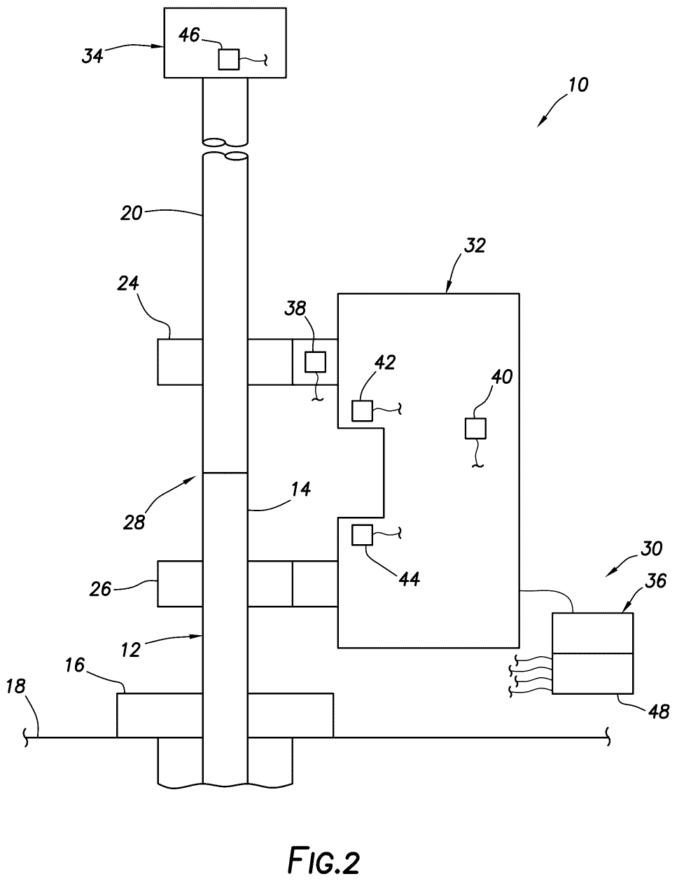

Referring additionally now to FIG. 2, an example of the apparatus 30 as used with the FIG. 1 system 10 and method is representatively illustrated.

However, the apparatus 30 may be used with other systems and methods in keeping with the principles of this disclosure.

In the FIG. 2 example, a tong assembly 32 is used to make-up and break-out the threaded connections 28 in the tubular string 12. In other examples, a top drive 34 may be used for applying torque and rotation to the upper tubular 20 in a tubular running operation. As depicted in FIG. 2, the tong assembly 32 includes the rotary clamp 24 and the backup clamp 26.

In the FIG. 2 threaded connection, the coupling 22 is not used. Instead, the upper tubular 20 is threaded directly into the lower tubular 14.

The apparatus 30 includes a control system 36 for controlling operation of the tong assembly 32 (or the top drive 34, or other tubular running equipment). The control system 36 receives sensor data output by various sensors 38, 40, 42, 44, 46. In the FIG. 2 example, the sensors 38, 40, 42, 44, 46 are mounted to the tubular running equipment (e.g., with sensors 38, 40, 42, 44 being mounted in or on the tong assembly 32, and the sensor 46 being mounted in or on the top drive 34), but in other examples the sensors could be mounted in other locations.

In this example, the sensor 38 is a torque sensor that measures torque applied to the tubular 20 by the upper clamp 24, the sensor 40 is a rotation sensor that measures turns applied to the tubular 20 by the rotary clamp, the sensor 42 is an accelerometer that measures acceleration (including vibration, etc.), and the sensor 44 is a gyroscope that detects orientation. If the top drive 34 is used, the sensor 46 can comprise one or more of a torque sensor, a rotation sensor, an accelerometer and a gyroscope. The scope of this disclosure is not limited to any particular type, number or combination of sensors used with the control system 36.

Measurements output by the sensors 38, 40, 42, 44, 46 are input to a frequency spectrum analysis module 48 of the control system 36. The frequency spectrum analysis module 48 is used to identify in real time any cyclical disturbances or vibration patterns that may indicate a defect or anomaly occurring during the tubular running operation. Such cyclical disturbances or vibration patterns may result from, for example, misalignment of the tubular running equipment, gear or bearing defects, insufficient lubrication, slippage of the backup clamp 26, etc. However, the scope of this disclosure is not limited to identification of any particular type or combination of defects or anomalies using the frequency spectrum analysis module 48.

The module 48 may comprise any suitable software, firmware, hardware, instructions, input and output devices, etc., as needed to perform frequency spectrum analysis on the sensor data. For example, the module 48 can include one or more of Fast Fourier Transform (FFT), short-time Fourier transform (STFT), continuous wavelet transform (CWT), discrete wavelet transform (DWT), machine learning, filtering, trend correction, auto-correlation and pattern matching programming, routines or instructions for performing the frequency spectrum analysis.

The control system 36 can control operation of the tong assembly 32 or the top drive 34, based at least in part on the frequency spectrum analysis performed using the module 48. For example, a threaded connection make-up process may be terminated, and/or the threaded connection 28 may be rejected, if a defect or anomaly is identified. As another example, maintenance or repair of the tubular running equipment may be required, based on the identified defect or anomaly.

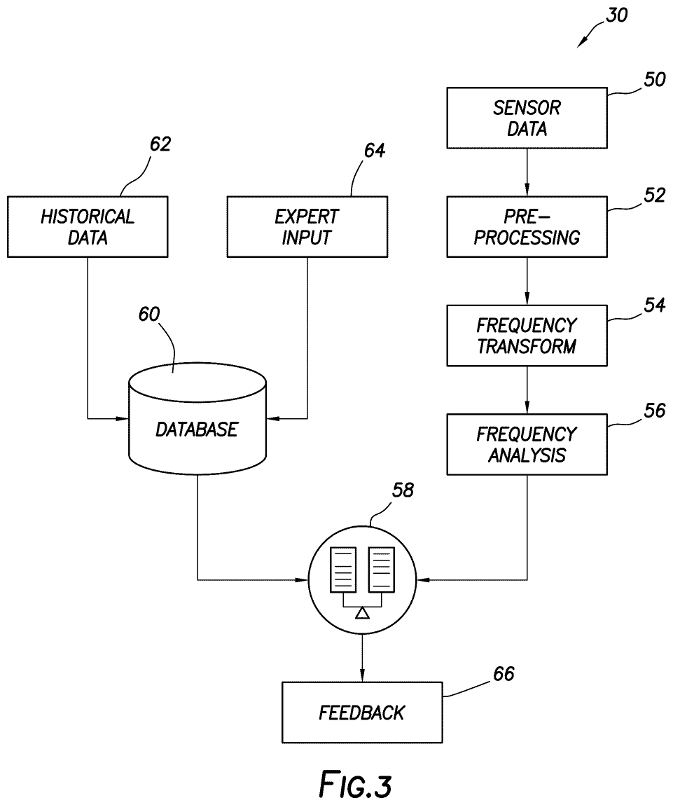

Referring additionally now to FIG. 3, an example workflow of the apparatus 30 is schematically illustrated. For convenience, the FIG. 3 workflow is described below as it may be used with the FIGS. 1 & 2 system 10, method and apparatus 30, but in other examples the workflow may be used with other systems, methods or apparatus.

As depicted in the FIG. 3 example, sensor data 50 is output by the sensors 38, 40, 42, 44, 46. The sensor data 50 is input to the frequency spectrum analysis module 48 of the control system 36.

The sensor data 50 is pre-processed, for example, to remove noise, irrelevant trends or data not of interest. The pre-processing 52 may include high and/or low pass filters, a Kalman filter, etc. The scope of this disclosure is not limited to any particular types or combinations of pre-processing 52 performed for the sensor data 50.

A frequency transformation 54 is performed on the pre-processed sensor data 50. The frequency transformation 54 converts the time domain sensor data 50 to frequency domain. For example, a Fourier transformation (or FFT), short-time Fourier transform (STFT), continuous wavelet transform (CWT), and/or discrete wavelet transform (DWT) may be used to perform the frequency transformation 54.

A frequency analysis 56 is then performed for the frequency domain sensor data 50. For example, the frequency analysis 56 may include machine learning, trend correction, auto-correlation, pattern matching and/or other techniques to identify any cyclical disturbances or vibration patterns in the frequency domain sensor data 50.

A comparison 58 is then made between the frequency patterns identified by the frequency analysis 56 and known frequency patterns stored in a database 60. The known frequency patterns correspond to certain defects or anomalies (such as, misalignment, gear or bearing defects, insufficient lubrication, slippage of the backup clamp 26, etc.). In this manner, if the comparison 58 reveals that the frequency patterns identified by the frequency analysis 56 exactly or substantially match a known frequency pattern stored in the database 60, then the corresponding defects or anomalies are also identified.

The known frequency patterns stored in the database 60 may be derived from historical data 62 or may result from expert input 64. The historical data 62 may be from previous tubular running operations, and/or from prior data collected in the current tubular running operation (e.g., resulting from prior make-up or break-out processes). The expert input 64 may result from, for example, expert analysis of structural and operational characteristics of the system 10. An expert could conclude, for example, that if a motor of the tong assembly 32 rotates at a certain rotational speed, then a peak at a corresponding frequency in the accelerometer 42 output could indicate a bearing or gear failure.

Gear defects can manifest as high-frequency vibrations with specific frequency signatures corresponding to gear mesh frequency. Bearing defects can produce characteristic frequencies related to an inner race, outer race, or rolling elements, which can be identified through spectrum analysis.

If there is misalignment during the threaded connection make-up or break-out process, it can produce a distinct frequency pattern characterized by periodic disturbances at specific harmonic frequencies. These patterns can be detected using FFT, STFT, CWT, DWT, machine learning and auto-correlation techniques.

Lack of lubrication can lead to increased friction, which causes higher amplitude vibrations at multiple frequencies. The frequency spectrum will show elevated levels of vibration across a broad range of frequencies if there is insufficient lubrication.

Slippage of the backup clamp 26 can be detected by sudden changes in the frequency spectrum, indicating irregularities in the rotational speed. This can be identified by monitoring frequency shifts and amplitude changes in the torque and turn sensor data.

Certain operational conditions might induce vibrations at specific frequencies, which are not present during normal operations. These induced vibrations can be detected by analyzing the frequency spectrum for new or abnormal frequency components.

Feedback 66 is provided, based on the comparison 58. Preferably, the feedback 66 is provided in real time during the tubular running operation. If there are no defects or anomalies identified by the comparison 58, then the tubular running operation can proceed without delay. If one or more defects or anomalies are identified, then these can be corrected or mitigated as appropriate. The feedback 66 may be in the form of a display, alert, message, etc., provided to an operator, and/or the control system 36 may automatically control operation of the tubular running equipment as appropriate to correct or mitigate the defect or anomaly.

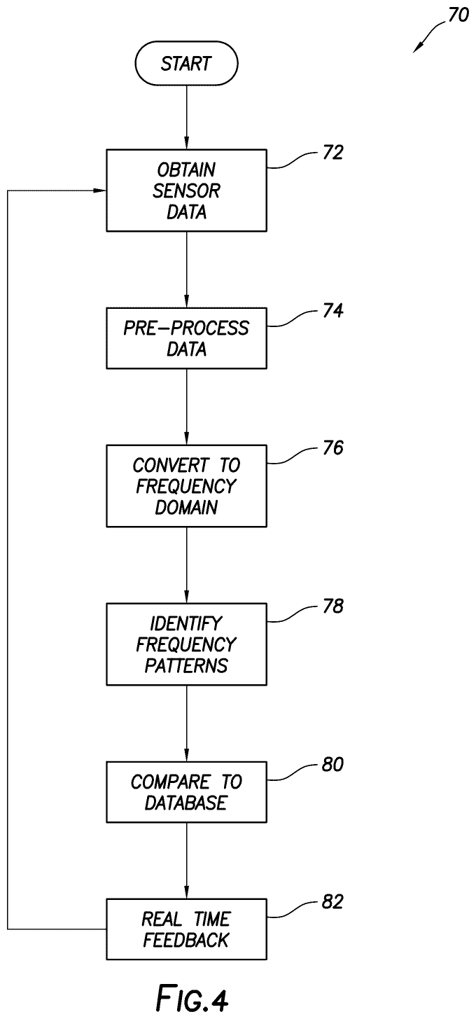

Referring additionally now to FIG. 4, an example method 70 is representatively illustrated in flowchart form. For convenience, the method 70 is described below as it may be used with the system 10 and apparatus 30, but the method may be used with other systems and apparatus in other examples.

In an initial step 72, the sensor data 50 is obtained and input to the control system 36 frequency spectrum analysis module 48. The sensor data 50 in this example can include torque measurements (from the sensor 38), rotation measurements (from the sensor 40), acceleration measurements (from the sensor 42), orientation measurements (from the sensor 44), and data from the top drive sensor(s) 46, in the time domain. Other measurements may be used in other examples.

In step 74, the sensor data 50 is pre-processed. The pre-processing may include filtering the sensor data 50, removing noise and irrelevant trends, etc.

In step 76, the pre-processed time domain sensor data 50 is then converted to the frequency domain. For example, a FFT, STFT, CWT and/or DWT may be performed on the sensor data 50.

In step 78, frequency patterns indicating, for example, cyclical disturbances or certain vibration patterns, are identified in the frequency domain sensor data 50. Machine learning algorithms or artificial intelligence may be used to identify the cyclical disturbances or vibration patterns.

In step 80, the frequency patterns identified in step 78 are compared to the known frequency patterns stored in the database 60. The frequency spectrum analysis module 48 may use techniques such as artificial intelligence, auto-correlation, machine learning and pattern matching to perform the comparison 58.

In step 82, the feedback 66 is provided, preferably in real time, so that any identified defects or anomalies can be communicated to an operator, and corrected or mitigated immediately. If no defects or anomalies are identified in step 80, then the feedback 66 may include acceptance of the current threaded connection make-up or break-out process and proceeding to the next make-up or break-out process (e.g., return to step 72). If defects or anomalies are identified in step 80, then the feedback 66 may be to reject the threaded connection 28, require repair or mitigation of the defects or anomalies, and/or otherwise control the tubular running operation as appropriate.

An alert, report, alarm or other type of visual, audible or textual notification may be output if defects or anomalies are identified in step 80. In one example, the control system 36 can generate a report summarizing the frequency pattern analysis and operational recommendations. A user interface can display real-time sensor data and frequency pattern analysis results.

It may now be fully appreciated that the above disclosure provides significant advancements to the art of running tubular strings into and out of a subterranean well. In examples described above, frequency spectrum analysis of sensor data can be used to identify any defects or anomalies in a tubular running operation.

The above disclosure provides to the art a method 70 for use with a subterranean well. In one example, the method 70 can comprise: obtaining sensor data 50 during a tubular running operation; converting the sensor data 50 to frequency domain; identifying at least one frequency pattern in the sensor data 50; and comparing the identified at least one frequency pattern to a database 60 of known frequency patterns.

The method 70 can include controlling the tubular running operation based on the comparing step. The controlling step may include accepting or rejecting a threaded connection 28 based on the comparing. The controlling step may be performed in real time during the tubular running operation.

The converting step may include performing for the sensor data 50 at least one of the group consisting of fast Fourier transform, short-time Fourier transform, continuous wavelet transform and discrete wavelet transform.

The method 70 may include processing the sensor data 50 prior to the converting step. The processing step may include filtering noise from the sensor data 50.

The sensor data 50 may be output by at least one of a torque sensor 38, a rotation sensor 40, a gyroscope 44 and an accelerometer 42. The method may include mounting at least one sensor 38, 40, 42, 44, 46 to tubular running equipment, whereby the sensor outputs the sensor data 50. The tubular running equipment may be selected from a tong assembly 32 and a top drive 34.

The above disclosure also provides to the art an apparatus 30 for use with a subterranean well. In one example, the apparatus 30 comprise: at least one sensor 38, 40, 42, 44, 46 configured to output sensor data 50 in a tubular running operation; and a control system 36 comprising a frequency spectrum analysis module 48 configured to convert the sensor data 50 to frequency domain.

The sensor may be selected from an accelerometer 42, a gyroscope 44, a torque sensor 38 and a rotation sensor 40.

The control system 36 may include a database 60 of known frequency patterns.

The control system 36 may be configured to identify at least one frequency pattern in the frequency domain sensor data 50. The control system 36 may be configured to compare the identified frequency pattern to the database 60 of known frequency patterns.

The control system 36 may be configured to control the tubular running operation in response to a comparison of the identified frequency pattern to the database 60 of known frequency patterns. The control system 36 may be configured to identify a defect in tubular running equipment in response to a comparison of the identified frequency pattern to the database 60 of known frequency patterns.

The sensor 38, 40, 42, 44, 46 may be mounted to tubular running equipment. The tubular running equipment may be selected from a tong assembly 32 and a top drive 34.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method for use with a subterranean well, the method comprising:
obtaining sensor data during a tubular running operation;
converting the sensor data to frequency domain;
identifying at least one frequency pattern in the sensor data; and
comparing the identified at least one frequency pattern to a database of known frequency patterns.

2. The method of claim 1, further comprising controlling the tubular running operation based on the comparing.

3. The method of claim 2, in which the controlling comprises accepting or rejecting a threaded connection based on the comparing.

4. The method of claim 2, in which the controlling is performed in real time during the tubular running operation.

5. The method of claim 1, in which the converting comprises performing for the sensor data at least one of the group consisting of fast Fourier transform, short-time Fourier transform, continuous wavelet transform and discrete wavelet transform.

6. The method of claim 1, further comprising processing the sensor data prior to the converting.

7. The method of claim 6, in which the processing comprises filtering noise from the sensor data.

8. The method of claim 1, in which the sensor data is output by at least one of the group consisting of a torque sensor, a rotation sensor, a gyroscope and an accelerometer.

9. The method of claim 1, further comprising mounting at least one sensor to tubular running equipment, whereby the at least one sensor outputs the sensor data.

10. The method of claim 9, in which the tubular running equipment is selected from the group consisting of a tong assembly and a top drive.

11. An apparatus for use with a subterranean well, the apparatus comprising:
at least one sensor configured to output sensor data in a tubular running operation; and
a control system comprising a frequency spectrum analysis module configured to convert the sensor data to frequency domain.

12. The apparatus of claim 11, in which the sensor is selected from the group consisting of an accelerometer and a gyroscope.

13. The apparatus of claim 11, in which the sensor is selected from the group consisting of a torque sensor and a rotation sensor.

14. The apparatus of claim 11, in which the control system further comprises a database of known frequency patterns.

15. The apparatus of claim 14, in which the control system is further configured to identify at least one frequency pattern in the frequency domain sensor data.

16. The apparatus of claim 15, in which the control system is further configured to compare the identified frequency pattern to the database of known frequency patterns.

17. The apparatus of claim 15, in which the control system is further configured to control the tubular running operation in response to a comparison of the identified frequency pattern to the database of known frequency patterns.

18. The apparatus of claim 15, in which the control system is further configured to identify a defect in tubular running equipment in response to a comparison of the identified frequency pattern to the database of known frequency patterns.

19. The apparatus of claim 11, in which the at least one sensor is mounted to tubular running equipment.

20. The apparatus of claim 19, in which the tubular running equipment is selected from the group consisting of a tong assembly and a top drive.
